(19) United States
(12) Patent Application Publication
(10) Pub. No.: US 2007/0151358 A1
(43) Pub. Date: Jul. 5, 2007

(54) Circuit board monitoring system

(76) Inventors: Chao-Heng Chien, Taipei (TW); Yi-Ying Chu, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/408,649

(22) Filed: Apr. 21, 2006

(30) Foreign Application Priority Data
Dec. 16, 2005 (TW) 094144827

(51) Int. Cl. G01D 1/16

(52) U.S. Cl. 73/790

(57) ABSTRACT

An instant monitoring system, applied to a circuit board, for inspecting an area under stress on the circuit board, comprises a strain gage, with a thin film structure, and at least one resistance, while the strain gage, with a first resistance value before receiving a stress, is embedded on the area, which receiving a stress, of the circuit board. The strain gage and the resistances, with the same first resistance value, connect electrically to form a Wheatstone bridge circuit.

### CROSS-REFERENCES TO RELATED APPLICATIONS

This application claims priority to Taiwan Patent Application No. 094144827 filed on Dec. 16, 2005.

### BACKGROUND OF THE INVENTION

1. Field of the Invention

The present invention relates to a stress monitoring system, especially to an instant stress monitoring system applied to a circuit board.

2. Descriptions of the Related Art

The development of miniaturization in electronic technology since the end of 20 century brings a second industrial revolution for human science and technology. The progress of these thirty to forty years is far beyond that of past thousand years. According to the eager requirement about product miniaturization for people, the technologies in the micrometer era have been developed into the era of nanometer. The development trend of technological products is towards being light, tiny, short, cheap and multifunction. According to the effect of product miniaturization, the testing and verification for electronic products become essential during the process of design and manufacture to ensure the quality and reliability thereof.

Meanwhile, as a result of miniaturization of circuit boards in electronic products, the heat and the corresponding thermal stress generated during the operation process of the electronic components or the mechanical stress generated during the stage of manufacture and utilization are key factors to determine whether the products are under normal operation or not. Therefore, it is essential to inspect or to monitor the circuit board in electronic products. Presently, the method for the industry to inspect the stress is to paste strain gages, available in the market, on the test item. For example, strain gages, with 120 ohms available in the market, are pasted on the areas in the neighborhood where thermal or mechanical stresses are generated, to form a Wheatstone bridge circuit after a proper disposition for inspecting the stress variation.

The theory of manipulating a strain gage is that the variation of resistance will be generated according to a strain of a metal line. Therefore, the variation of stresses will be measured near the area where the strain gages are pasted on. However, this inspection method exists a possible error as the strain gages are pasted. Moreover, this method also has a disadvantage of failing to inspect instantaneously. The regular strain gages, available on the market, are not able to meet the requirement for precisely measuring the stress variation of a tiny area inside an electronic product. Accordingly, it is essential to develop an instant monitoring system for a circuit board with respect to the miniaturization of electronic products in order to find out the area with high stress variation and to do the necessary protective actions to enhance the quality and the reliability of those products correspondingly.

### SUMMARY OF THE INVENTION

According to the above-mentioned issues, the primary object of the present invention is to provide an instant monitoring system, applied to a circuit board, for inspecting an area under stress on the circuit board instantaneously. The instant monitoring system comprises a strain gage and at least one fixed resistance. The strain gage, with a thin film structure, is embedded on the area under stress of the circuit board. The strain gage has a first resistance value before receiving the stress. Moreover, the fixed resistance also has the first resistance value and is connected electrically with the strain gage to form a Wheatstone bridge circuit.

Another object of the present invention is to provide a resistance bridge circuit, applied to a circuit board, for inspecting an area under stress on the circuit board instantaneously. The resistance bridge circuit comprises a strain gage and at least one fixed resistance. The strain gage, with a thin film structure, is embedded on the area under stress of the circuit board. The strain gage has a first resistance value before receiving the stress, wherein the strain gage further comprises a resistance portion and two electrode portions. Each of two opposition ends of the resistance portion is connected electrically with each of the two electrode portions respectively. Each fixed resistance has the first resistance value and is connected electrically with electrode portions of the strain gage to form a Wheatstone bridge circuit.

Yet a further object of the present invention is to provide a strain gage, with a thin film structure, which is embedded on a circuit board for inspecting stress variation on the circuit board. The strain gage comprises a resistance portion and two electrode portions, wherein each of two opposition ends of the resistance portion is connected electrically with each of the two electrode portions respectively.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating a strain gage of the present invention;

FIG. 2 is a schematic view illustrating a strain gage disposed on a circuit board of the present invention; and

FIG. 3 is a schematic view illustrating a resistance bridge circuit of the present invention.

### DESCRIPTION OF THE PREFERRED EMBODIMENT

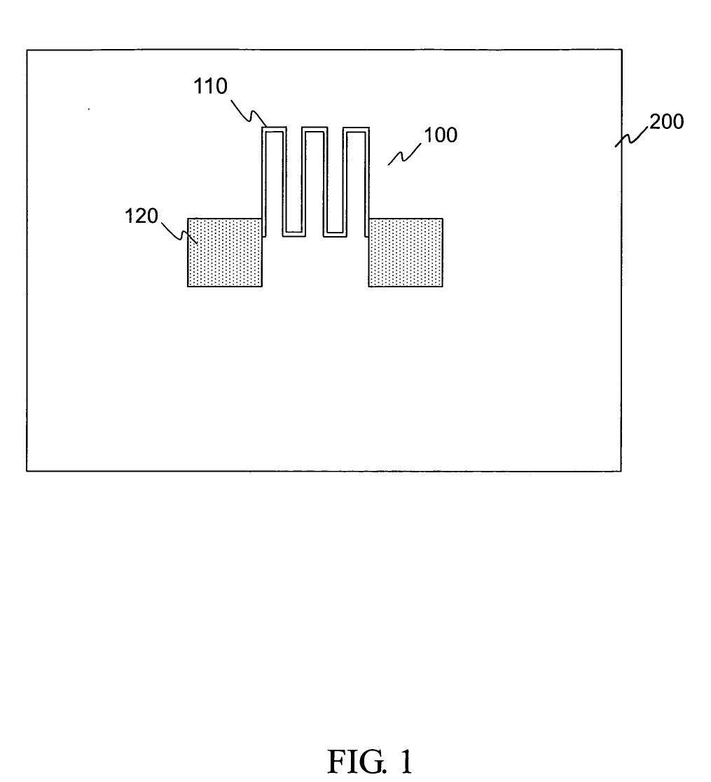

A schematic view illustrating a strain gage 100 with a thin film structure applying the techniques of the present invention is shown in FIG. 1. The strain gage is embedded on a circuit board 200 (not shown as a realistic scale) for inspecting stress variation on the circuit board 200. Meanwhile, the strain gage applying the techniques of the present invention comprises a resistance portion 110 and two electrode portions 120. Each of two opposition ends of the resistance portion 110 is connected electrically with each of the two electrode portions 120 respectively, wherein the material of the resistance portion 110 is one of the metal material with high resistance (ρ), such as Ni, Cr and the material of the electrode portion 120 is one of the metal material with low resistance (ρ), such as Ti, Au, Ag, etc.

Compared with the prior art, the characteristic of the present invention mainly is to form a strain gage with a thin film structure on a circuit board directly by thin-film deposition. It is quite different from the prior art which pastes the strain gage on the circuit board after it was solely manufactured. Therefore, an error owing to the paste procedure of the above-mentioned could be avoided. Moreover, a residual stress generated during the paste procedure could also be avoided to enhance the accuracy of the subsequent measuring result.

More specifically, the thin-film deposition manufacturing the strain gage of the present invention could utilize the methods including physical vapor deposition (PVD), sputtering, electroplating, screenprinting, and so forth. It is noted that there are different manufacture methods to be selected corresponding to the different requirements of real testing as manufacturing the strain gage of the present invention. For example, if a single material is selected to form the strain gage of the present invention, a method of evaporation would be selected. If a composite material is utilized to form the strain gage of the present invention, a method of sputtering would be preferred. Especially, utilizing the progress of manufacture procedures of the electronic products, the strain gage, with a thin film structure, of the present invention would meet the trend of miniaturization of electronic products. In other words, the strain gage disclosed by the present invention would be directly embedded on an expected position on a circuit board to inspect the stress variation of a tiny area thereon. By proper circuit arrangement, a signal detected by the strain gage would be captured for the subsequent further utilization.

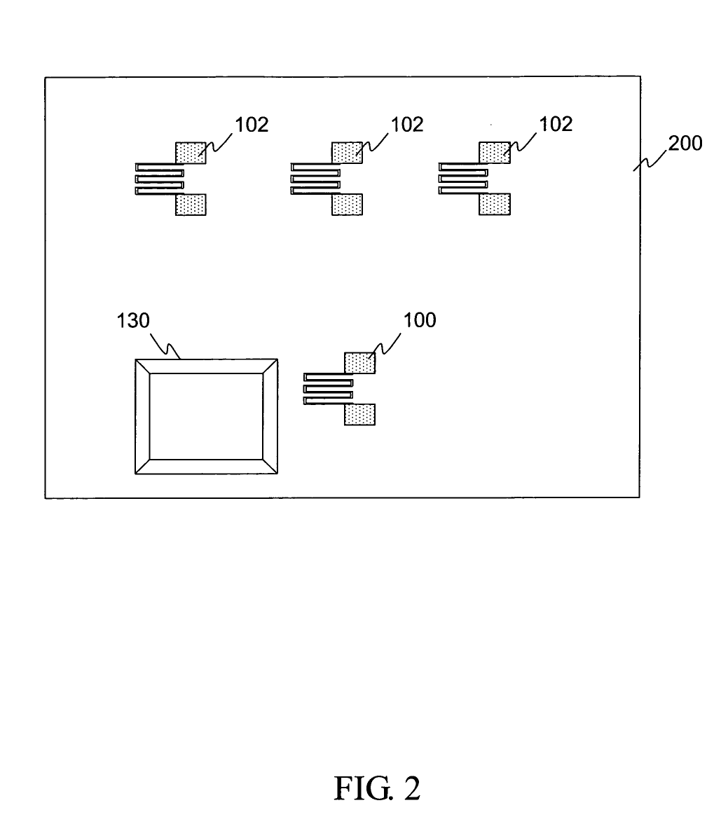

More specifically, the strain gage of the present invention would be applied to a circuit board to act as a basic component of a resistance bridge circuit for the purpose of monitoring an area under stress on the circuit board. Please refer to FIG. 2, it illustrates a schematic view of a strain gage of the present invention applied to a circuit board. The bridge circuit comprises strain gage 100, with a thin film structure, and at least one fixed resistance 102, such as three fixed resistances embedded on a circuit board 200. In a preferred embodiment of the present invention, these fixed resistances 102 and the strain gage 100 of the present invention would be formed on different places of the circuit board 200 during the same manufacture procedure. Thus, they have substantially the same resistance value to form a Wheatstone bridge together.

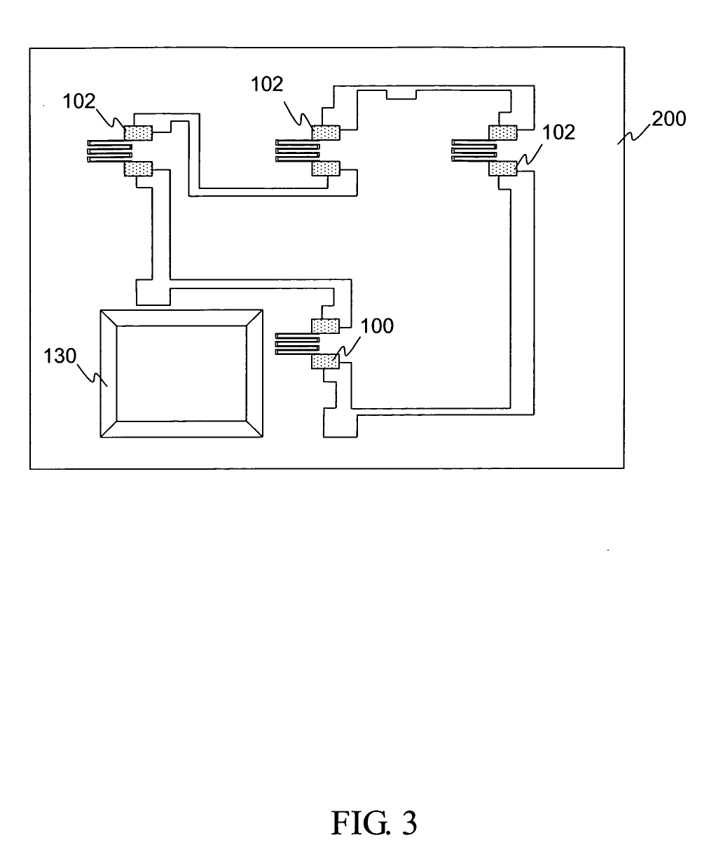

Next, regarding the disposition arrangement, the strain gage 100 of the present invention would be disposed near an area where stress variation is expected to be generated on the circuit board, for example, an area near an electronic component 130 which generates heat easily or an area (not illustrated) where a mechanical stress is easily generated. After that, configure the other three fixed resistance 102 on an area substantially far away from the electronic component 130 to avoid the influence of thermal stress or mechanical stress thereof. At last, a proper circuit arrangement is utilized to connect electrically the two electrode portions of the strain gage 100 with the other three fixed resistances 102 to form a Wheatstone bridge circuit, as illustrated in FIG. 3.

It is noted that those skilled in the art may proceed with a variety of modifications and replacements based on the disclosures and suggestions of the invention. For example, the fixed resistance of the Wheatstone bridge circuit of the present invention does not limit to be disposed on the circuit board. In a real application, these fixed resistances could be disposed on the other areas, out of the circuit board for example or not affected by the stress. Only a proper circuit connection is needed to form a complete bridge circuit. Moreover, the fixed resistance 102 applied in the present invention does not limit to be made during the same procedure of forming the strain gage 100. Any other resistance has the same resistance value of the strain gage 100 and the same effect thereof could also be utilized in this invention.

In another embodiment, the strain gage of the Wheatstone bridge circuit of the present invention would further connect electrically to a signal amplifier to form an instant monitoring system of a circuit board. For example, a wireless transmission module would be utilized to connect electrically to the signal amplifier for transmitting the voltage signal. Specifically, the amplifier is utilized to amplify a voltage signal of the Wheatstone bridge circuit. A microprocessor, such as a single chip microcomputer, is utilized to connect electrically with the amplifier to capture the voltage signal.

Next, after calculating the voltage signal, the strain detected by the strain gage would be calculated instantaneously in order to disclose the real status of receiving stress on the area where the strain gage is pasted. In a real application, a proper standard would be set on the microprocessor according to the technique disclosed by the present invention to provide the circuit board proper protection. For example, in real operation, as the signal, from the strain gage and received by the microprocessor, is larger than a critical value of operating the circuit board, a signal for protecting the circuits will be output from the microprocessor. According to the signal, the circuit board will stop operating in the manners of manual or automatic setting to protect the circuit board from a further damage. Therefore, the instant monitoring system of the present invention could provide users instant and necessary information about the circuit board during a period of a development stage or an operation stage of an electronic product to act as an important reference and provide the peripheral circuit the necessary protection. It is helpful to enhance the quality and reliability of electronic products.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An instant monitoring system, applied to a circuit board, for inspecting an area under stress on the circuit board, the instant monitoring system comprising:
a strain gage, with a thin film structure, embedded on the area under stress of the circuit board, the strain gage having a first resistance value before receiving the stress; and
at least one fixed resistance, with the first resistance value, connected electrically with the strain gage to form a Wheatstone bridge circuit.

2. The instant monitoring system of claim 1, further comprising a signal amplifier connected electrically with the Wheatstone bridge circuit for amplifying a voltage signal of the Wheatstone bridge circuit.

3. The instant monitoring system of claim 2, further comprising a microprocessor connected electrically with the signal amplifier for capturing the voltage signal and output a signal to protect the circuit board.

4. The instant monitoring system of claim 3, wherein the microprocessor is a single chip microcomputer.

5. The instant monitoring system of claim 2, further comprising a wireless transmission module connected electrically with the signal amplifier for transmitting the voltage signal.

6. The instant monitoring system of claim 1, wherein the strain gage with the thin film structure is formed on the circuit board by thin-film deposition.

7. The instant monitoring system of claim 6, wherein the thin-film deposition is physical vapor deposition (PVD).

8. The instant monitoring system of claim 6, wherein the thin-film deposition is electroplating.

9. The instant monitoring system of claim 6, wherein the thin-film deposition is screenprinting.

10. The instant monitoring system of claim 6, wherein the thin-film deposition is sputtering.

11. The instant monitoring system of claim 1, wherein the strain gage further comprises a resistance portion and two electrode portions, each of two opposition ends of the resistance portion connected electrically with each of the two electrode portions respectively.

12. The instant monitoring system of claim 11, wherein the material of the resistance portion is one of metal materials with high resistance (ρ).

13. The instant monitoring system of claim 11, wherein the material of the electrode portion is one of metal materials with low resistance (ρ).

14. A resistance bridge circuit, applied to a circuit board, for inspecting an area under stress on the circuit board instantaneously, the resistance bridge circuit comprising:
a strain gage, with a thin film structure, embedded on the area under stress of the circuit board, the strain gage having a first resistance value before receiving the stress, wherein the strain gage comprises a resistance portion and two electrode portions, each of two opposition ends of the resistance portion connected electrically with each of the two electrode portions respectively; and
at least one fixed resistance, with the first resistance value, connected electrically with the two electrode portions of the strain gage to form a Wheatstone bridge circuit.

15. The resistance bridge circuit of claim 14, wherein the material of the resistance portion is one of metal materials with high resistance (ρ).

16. The resistance bridge circuit of claim 14, wherein the material of the electrode portion is one of metal materials with low resistance (ρ).

17. The resistance bridge circuit of claim 14, wherein the strain gage with the thin film structure is formed on the circuit board by thin-film deposition.

18. The resistance bridge circuit of claim 17, wherein the thin-film deposition is physical vapor deposition (PVD).

19. The resistance bridge circuit of claim 17, wherein the thin-film deposition is electroplating.

20. The resistance bridge circuit of claim 17, wherein the thin-film deposition is screenprinting.

21. The resistance bridge circuit of claim 17, wherein the thin-film deposition is sputtering.

22. A strain gage, with a thin film structure, embedded on a circuit board, for inspecting stress variation on the circuit board, the strain gage comprising:
a resistance portion; and
two electrode portions, wherein each of two opposition ends of the resistance portion is connected electrically with each of the two electrode portions respectively.

23. The strain gage of claim 22, wherein the material of the resistance portion is one of metal materials with high resistance (ρ).

24. The strain gage of claim 22, wherein the material of the electrode portion is one of metal materials with low resistance (ρ).

25. The strain gage of claim 22, wherein the strain gage with the thin film structure is formed on the circuit board by thin-film deposition.

26. The strain gage of claim 25, wherein the thin-film deposition is physical vapor deposition (PVD).

27. The strain gage of claim 25, wherein the thin-film deposition is electroplating.

28. The strain gage of claim 25, wherein the thin-film deposition is screenprinting.

29. The strain gage of claim 25, wherein the thin-film deposition is sputtering.

30. The strain gage of claim 22, wherein the strain gage has a first resistance value.

31. The strain gage of claim 30, wherein the strain gage is connected electrically with at least one fixed resistance having the first resistance value to form a Wheatstone bridge circuit.
